(19) United States
(12) Patent Application Publication
(10) Pub. No.: US 2026/0167574 A1
(43) Pub. Date: Jun. 18, 2026

(54) AEROGEL COMPOSITE MATERIAL AND METHOD OF MANUFACTURING AEROGEL COMPOSITE MATERIAL, AND METHOD FOR TREATING AEROGEL POWDER

(71) Applicant: Owens Corning Intellectual Capital, LLC, Toledo, OH (US)

(72) Inventors: Hongze LI, Hangzhou, Zhejiang (CN); Zheng LI, Hangzhou, Zhejiang (CN); Shuqing ZHOU, Hangzhou, Zhejiang (CN); Wenbin QUE, Hangzhou, Zhejiang (CN)

(21) Appl. No.: 19/119,819

(22) PCT Filed: Sep. 6, 2024
(86) PCT No.: PCT/CN2024/117398

§ 371 Date: Apr. 10, 2025

(30) Foreign Application Priority Data
Sep. 7, 2023 (CN) 202311152915.X

(51) Int. Cl. C04B 35/82; B32B 5/02; B32B 5/16; B32B 5/30; C04B 35/626; C04B 35/628; C04B 38/00

(52) U.S. Cl. CPC C04B 35/82; B32B 5/022; B32B 5/16; B32B 5/30; C04B 35/62675; C04B 35/62849; C04B 35/62892; C04B 38/0045; B32B 2260/021; B32B 2260/04; B32B 2262/0253; B32B 2262/101; B32B 2305/026; B32B 2307/718; B32B 2307/72; B32B 2307/724; B32B 2307/7376; C04B 2235/3418; C04B 2235/3826; C04B 2235/5212; C04B 2235/5232; C04B 2235/5252; C04B 2235/5427

(57) ABSTRACT

An aerogel composite material comprises a porous fiber material and an aerogel powder distributed in the porous fiber material, wherein the aerogel powder undergoes pre-heat treatment; the pre-heat treatment temperature ranges from 300° C. to 600° C.; the pre-heat treatment time is 30 minutes to 5 hours; and the preheated aerogel powder is impregnated in the porous fiber material by applying an alternating electric field to the porous fiber material. This technology can ensure that the porous fiber felt material is not damaged by high temperature, and due to the pre-heated treatment of the aerogel powder, the flame retardancy of the composite material is greatly enhanced, and the powder dropout of the aerogel is greatly improved.

### BACKGROUND

The present invention relates to the technical field of aerogel, and in particular to an aerogel composite material and a method of manufacturing an aerogel composite material, and a method for treating an aerogel powder.

Aerogel composite material is a new advanced material, which is made by the combination of aerogel powder and fiber materials through a special process. It has the characteristics of light weight, heat insulation with high efficiency, fire prevention and Eco-friendly, and is widely used in construction, petroleum, aerospace and other fields.

At present, aerogel composite material is mainly manufactured by a supercritical drying method. The supercritical drying method is to replace the solvent in the sol-gel pre-impregnated in the fiber material by using the special properties of supercritical fluid (such as carbon dioxide), so as to achieve the transformation of sol-gel to aerogel, and make the aerogel grow in situ in the fiber material. Aerogel composite materials (such as Chinese patents CN100540257C, CN105906298A) are manufactured by this way. During the transition from sol-gel to aerogel, in order to prevent the nanopore structure of aerogel from being damaged by fluid influence, the particle surface of aerogel is usually hydrophobically modified with alkyl modifiers to make its structure more stable. However, the addition of alkyl organic modifiers increases the combustible content of aerogel, resulting in a significant decrease in their flame retardant properties, and the hydrophobic surface of alkyl modified aerogel reduces its amphiphilicity with most materials, especially glass fiber felt.

### SUMMARY

A series of simplified concepts is introduced into the portion of Summary, which would be further illustrated in the portion of the detailed description. The Summary of the present invention does not mean attempting to define the key feature and essential technical feature of the claimed technical solution, let alone determining the protection scope thereof.

The present invention provides an aerogel composite material, comprising:
a porous fiber material;
a preheated aerogel powder distributed in the porous fiber material, wherein the preheated aerogel powder was submitted to a heat-treatment within a temperature ranging from 300° C. to 600° C.; during 30 minutes to 5 hours;
wherein the preheated aerogel powder is impregnated in the porous fiber material by applying an alternating electric field to the porous fiber material.

In an optional embodiment, a voltage of the alternating electric field ranges from 0.1 KV to 50 KV, and a frequency ranges from 1 HZ to 800 HZ; an application time of the alternating electric field ranges from 30 seconds to 5 minutes.

In an optional embodiment, the porous fiber material is selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene, and a glass fiber composite felt, and a combination of the above.

In an optional embodiment, a surface density of the glass fiber non-woven fabric is between 20 g/m² and 500 g/m²; a thickness is between 0.3 mm and 4 mm; and an air permeability is between 200 L/m²/s and 3000 L/m²/s.

In an optional embodiment, a surface density of the glass fiber non-woven fabric is between 50 g/m² and 150 g/m²; a thickness is between 0.5 mm and 1.5 mm; and an air permeability is between 500 L/m²/s and 2000 L/m²/s.

In an optional embodiment, a surface density of the glass fiber non-woven fabric is between 90 g/m² and 135 g/m²; a thickness is between 0.8 mm and 1.3 mm; and an air permeability is between 1100 L/m²/s and 1800 L/m²/s.

In an optional embodiment, the polypropylene and the glass fiber composite felt is made by blending a polypropylene fiber with a glass fiber; a density of the polypropylene and the glass fiber composite felt is between 20 kg/m³ and 200 kg/m³, and a thickness is between 1 mm and 20 mm.

In an optional embodiment, a density of the polypropylene and the glass fiber composite felt is between 50 kg/m³ and 150 kg/m³, and a thickness is between 3 mm and 10 mm.

In an optional embodiment, an additive for inhibiting thermal radiation is added to the aerogel powder, and the additive is selected from at least one of silicon carbide, boron carbide, titanium oxide and boron nitride; a weight ratio of the additive to the aerogel powder ranges from 1 wt % to 15 wt %.

In an optional embodiment, a weight ratio of the additive to the aerogel powder ranges from 5 wt % to 12 wt %.

In an optional embodiment, a weight ratio of the aerogel powder to the aerogel composite material ranges from 1 wt % to 50 wt %.

The present invention further provides a method of manufacturing the aerogel composite material, wherein the method comprises the following steps:
impregnating a pre-heated aerogel powder into a porous fiber material by applying an alternating electric field, wherein a voltage of the alternating electric field ranges from 0.1 KV to 200 KV; a frequency ranges from 0.1 HZ to 800 HZ; a density of the aerogel powder ranges from 0.01 g/cm³ to 0.5 g/cm³; an average particle size of the aerogel powder is less than or equal to 500 μm; the pre-heat treatment temperature ranges from 300° C. to 600° C.; and the pre-heat treatment time is 30 minutes to 5 hours.

In an optional embodiment, an application time of the alternating electric field ranges from 30 seconds to 5 minutes.

In an optional embodiment, a step is further comprised to apply the aerogel powder to a surface of the porous fiber material and/or applying the aerogel powder to a loader that is at least partially subject to the alternating electric field.

In an optional embodiment, the porous fiber material and the aerogel powder are arranged between a lower electrode and an upper electrode, and the electrode is electrically insulated from each other through a dielectric and connected to a power supply such that the porous fiber material and the aerogel powder are subject to the alternating electric field.

The present invention further discloses a method for treating an aerogel powder, comprising:

heat treating an aerogel powder, wherein the pre-heat treatment temperature ranges from 300° C. to 600° C., and the pre-heat treatment time is 30 minutes to 5 hours.

In an optional embodiment, an atmosphere of the heat treatment is air.

The present invention provides an aerogel composite material. One of the innovations of the aerogel composite material provided by the invention is that the alternating electric field is applied to the process of preparing the aerogel composite material, so that the aerogel composite material of the invention has more prominent technical advantages compared with the aerogel composite material manufactured by the supercritical drying method or the slurry impregnation method in prior art or other prior arts. For example, compared to the supercritical drying method, there is no need to use a complex supercritical equipment and high energy consumption to produce supercritical fluid, and the aerogel composite material can be manufactured while meeting the requirements for the uniformity of distribution of aerogel powder by only needing to use the aerogel powder prepared by the alternating electric field of a simple structure and atmospheric pressure drying method, with simple manufacturing process, low input cost and low energy consumption. Compared to the aerogel slurry impregnation method, the aerogel composite material has better performance because it does not require solvent impregnation and thereby avoids the destruction of the structure of the aerogel powder. At the same time, the process does not include the use of solvents and drying, which reduces a lot of energy consumption.

Aerogel powder is impregnated into porous fiber materials by alternating electric field, and the aerogel powder has a large impregnation amount and is uniform such that the aerogel composite material has better thermal insulation properties. The process is simple, and the production cost is low.

In addition, the innovation of the present invention also lies in the use of a heat treatment process to pre-treat the aerogel powder, and then makes a secondary composite of the heat-treated aerogel powder and the porous fiber felt material. This technology can ensure that the porous fiber felt material is not damaged by high temperature, and due to the pre-heated treatment of the aerogel powder, the flame retardancy of the composite material is greatly improved, and at the same time, the reduction of the content of alkyl hydrophobic groups also improves its amphiphilicity with the porous fiber material, so that the powder dropout of the aerogel is greatly improved.

### BRIEF DESCRIPTION OF THE DRAWINGS

The following drawings are hereby incorporated as part of the present invention for the understanding of the present invention. The embodiments are illustrated and described in the drawings in order to explain the principles of the present invention.

In the drawings:

FIG. 1 is an electron micrograph photograph of a vertical cross-section of an aerogel composite material according to Example 1 of the present invention;

FIG. 2a is an electron micrograph photograph of a vertical cross-section of an aerogel composite material according to Example 2 of the present invention;

FIG. 2b is an electron micrograph photograph of a front side of the aerogel composite material according to Example 2 of the present invention;

FIG. 2c is an electron micrograph photograph of a back side of the aerogel composite material according to Example 2 of the present invention;

FIG. 3a is an electron micrograph photograph of a vertical cross-section of an aerogel composite material according to Comparative Example 1 of the present invention;

FIG. 3b is an electron micrograph photograph of a front side of an aerogel composite material according to Comparative Example 1 of the present invention;

FIG. 3c is an electron micrograph photograph of a back side of an aerogel composite material according to Comparative Example 1 of the present invention;

FIG. 4a is an electron micrograph photograph of a vertical cross-section of an aerogel composite material according to Comparative Example 2 of the present invention;

FIG. 4b is an electron micrograph photograph of a front side of an aerogel composite material according to Comparative Example 2 of the present invention;

FIG. 4c is an electron micrograph photograph of a back side of an aerogel composite material according to Comparative Example 2 of the present invention;

FIG. 5 shows a reference chart for testing powder fallout rate by a nitrile glove friction test method;

FIG. 6a shows a scorch photograph of sample 71 without pre-heat treatment for aerogel powder;

FIG. 6b shows a scorch photograph of sample 72 subjected to pre-heat treatment of aerogel powder at 300° C. for 30 minutes;

FIG. 6c shows a scorch photograph of sample 73 subjected to a pre-heat treatment of aerogel powder at 400° C. for 30 minutes;

FIG. 6d shows a scorch photograph of sample 74 subjected to pre-heat treatment of aerogel powder at 500° C. for 30 minutes;

FIG. 7a shows an electron micrograph photograph of sample 71 without pre-heat treatment for aerogel powder;

FIG. 7b shows an electron micrograph photograph of sample 74 subjected to pre-heat treatment of aerogel powder at 500° C. for 30 minutes.

### DETAILED DESCRIPTION

In the following description, numerous specific details are set forth in order to provide a more thorough understanding of the present invention. However, it is obvious to those skilled in this art that the present invention may be implemented without one or more of these details. Some technical features well-known in this art are not described in other examples in order to avoid confusion with the present invention.

In order to thoroughly understand the present invention, a detailed description will be provided in the following description to elaborate the aerogel composite material and the method of manufacturing the aerogel composite material, the method for treating the aerogel powder, and the aerogel powder of the present invention. Obviously, the implementation of the present invention is not limited to the specific details familiar to those skilled in the art. The preferred embodiments of the present invention are described in detail as follows. However, in addition to these detailed descriptions, the present invention may have other embodiments.

The exemplary embodiments according to the present invention will now be described in detail with reference to the drawings. However, these exemplary embodiments can be implemented in various forms but should not be construed as being limited to the embodiments set forth herein. It is to be understood that these embodiments are provided to make the disclosure of the invention thorough and complete, and that the ideas of these exemplary embodiments are fully communicated to those of ordinary skill in the art.

To at least partially solve the problem, a first aspect of the present invention provides an aerogel composite material. One of the innovations of the aerogel composite material provided by the invention is that the alternating electric field is applied to the process of preparing the aerogel composite material, so that the aerogel composite material of the invention has more prominent technical advantages compared with the aerogel composite material manufactured by the supercritical drying method or the slurry impregnation method in prior art or other prior arts. For example, compared to the supercritical drying method, there is no need to use a complex supercritical equipment and high energy consumption to produce supercritical fluid, and the aerogel composite material can be manufactured while meeting the requirements of the uniformity of distribution of aerogel powder by only needing to use the aerogel powder prepared by the alternating electric field with a simple structure and atmospheric pressure drying method, with simple manufacturing process, low input cost and low energy consumption. Compared to the aerogel slurry impregnation method, the aerogel composite material has better performance because it does not require solvent impregnation and thereby avoids the destruction of the structure of the aerogel powder. At the same time, the process does not include the use of solvents and drying, which reduces a lot of energy consumption.

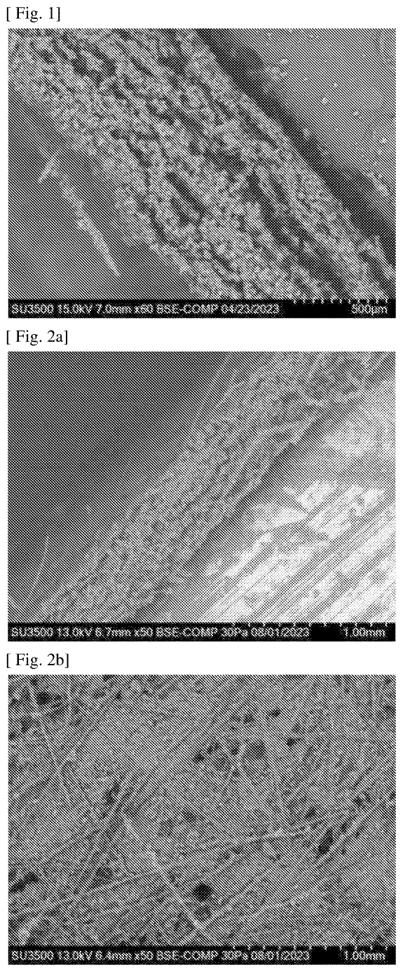

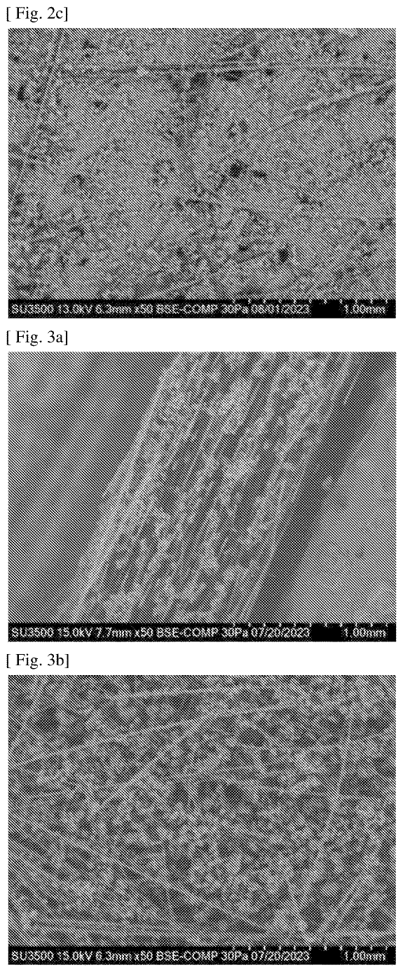

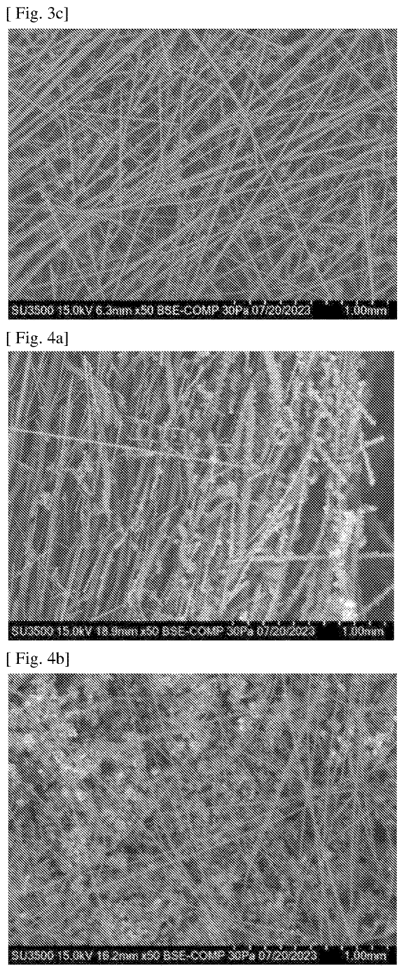

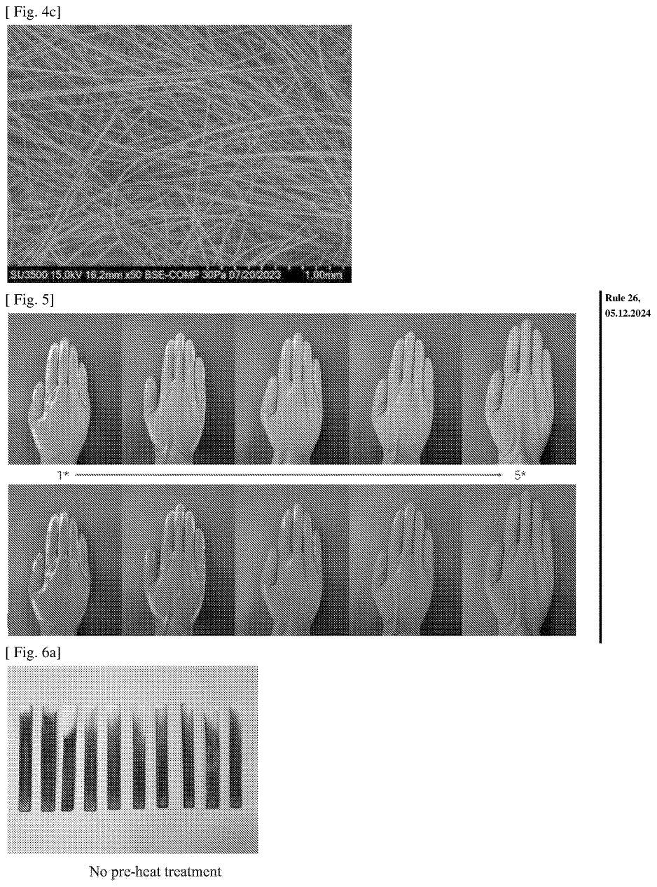

Specifically, the aerogel composite material disclosed in the present invention may include a porous fiber material and an aerogel powder distributed within the porous fiber material. By applying the alternating electric field to the porous fiber material, the aerogel powder is impregnated not only into the porous fiber material, but also is impregnated more uniformly. With reference to FIG. 1 and FIG. 2a, the electron micrograph photographs of the aerogel composite material of Examples 1 and 2 in vertical cross section are shown. Compared to FIG. 3a and FIG. 4a of Comparative Examples, it can be seen that the aerogel powder in the aerogel composite material of the invention is more evenly distributed and has a relatively large amount of impregnation. In multiple embodiments, the weight ratio of the aerogel powder to the aerogel composite material may range from 1 wt % to 50 wt %.

An alternating electric field refers to an electric field whose magnitude and direction change with time. It is produced by an alternating current power supply, in which the charge oscillates sometimes positively and sometimes negatively, causing a change in the electric field. The alternating electric field is characterized by periodic changes, and its frequency describes the rate of change in Hertz (Hz). The voltage range of the alternating electric field of the invention can be 0.1 KV to 50 KV, the frequency range can be 1 HZ to 800 HZ, and the application time of the alternating electric field can be 30 seconds to 5 minutes. Those skilled in the art can adjust any of the above parameters according to the actual needs of use and product conditions in the production process.

The density of the aerogel powder of the aerogel composite material of the present invention can range from 0.01 g/cm³ to 0.5 g/cm³, and the average particle size of theaerogel powder is less than or equal to 500 m. Preferably, the density of the aerogel powder can range from 0.03 g/cm³ to 0.1 g/cm³, and the average particle size of the aerogel powder is less than or equal to 50 m. For example, the aerogel powder may be JIOS aerogel Company AeroVa® aerogel powder (Chinese patent CN103771428B and US patent US20220306833 are incorporated by reference as a whole into this specification).

The porous fiber material can be selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene, and a glass fiber composite felt, and a combination of the above. Preferably, the porous fiber material can use the glass fiber non-woven fabric, whose areal density can be between 20 g/m² and 500 g/m², thickness can be between 0.3 mm and 4 mm, and air permeability can be between 200 L/m²/s and 3000 L/m²/s. Further preferably, the areal density can be between 50 g/m² and 150 g/m², the thickness can be between 0.5 mm and 1.5 mm, and the air permeability can be between 500 L/m²/s and 2000 L/m²/s, or the areal density is between 90 g/m² and 135 g/m², the thickness is between 0.8 mm and 1.3 mm, and the air permeability is between 1100 L/m²/s and 1800 L/m²/s.

As another preferred embodiment, the polypropylene and glass fiber composite felt with a density between 50 kg/m³ and 150 kg/m³ and thicknesses between 3 mm and 10 mm may also be selected for the porous fiber material. It should be noted that the present invention is not limited to the varieties of the porous fiber material specifically enumerated, as long as the fibrous material with porosity known to the person skilled in the art or the material equivalent to the porous fiber material that can accommodate the aerogel powder is within the protection scope limited by the invention.

In order to improve the thermal insulation and insulation properties of aerogel composite materials, an additive for inhibiting thermal radiation can also be added to the aerogel powder. For example, the additive may be selected from at least one of silicon carbide, boron carbide, titanium oxide and boron nitride. The weight ratio of the additive to the aerogel powder may range from 1 wt % to 15 wt %. Preferably, the weight ratio of the additive to the aerogel powder ranges from 5 wt % to 12 wt %.

A second aspect of the present invention further provides a method of manufacturing the aerogel composite material, wherein the method may fundamentally comprise the following steps:

Feeding: The aerogel powder is applied to the surface of the porous fiber material and/or onto a loader that is at least partially subject to an alternating electric field. For example, the loader may be a conveyor belt or a rotary feeder, or the like. The conveyor belt may be located above the porous fiber material and at least partially located in the alternating electric field. The aerogel powder may be transported through the conveyor belt, and the aerogel powder located on the conveyor belt may be impregnated into the porous fiber material when the alternating electric field is applied.

Treatment: The aerogel powder is impregnated into the porous fiber material by applying an alternating electric field, where the voltage range of the alternating electric field can be 0.1 KV to 200 KV, and the frequency ranges from 0.1 HZ to 800 HZ; the density of the aerogel powder ranges from 0.01 g/cm³ to 0.5 g/cm³, and the average particle size of the aerogel powder is less than or equal to 500 μm. The application time of the alternating electric field ranges from 30 seconds to 5 minutes.

In an optional embodiment, the porous fiber material and the aerogel powder are arranged between a lower electrode and an upper electrode, and the electrodes are electrically insulated from each other through a dielectric and connected to a power supply such that the porous fiber material and the aerogel powder are subject to the alternating electric field.

Further, in order to better describe the aerogel composite material and the method of manufacturing the aerogel composite material provided by the present invention, the invention provides a plurality of Examples and Comparative Examples to illustrate that the invention has more prominent technical advantages compared with the prior art.

### Example 1

Material: JIOS aerogel Company AeroVa® aerogel powder, particle size: D50<50 m, density: 0.03-0.1 g/cm³, and porosity >90%.

Owens Corning glass fiber non-woven fabric, gram weight: 125 g/m², thickness: 1.25 mm, and air permeability: 1300˜1350 L/m²/s.

High voltage alternating electric field: Consist of two electrodes. One electrode is grounded, and the other electrode is powered by high voltage alternating current. The maximum voltage is ±15 kv, sine wave, and frequency is 600 HZ.

Implementation process: The aerogel powder is evenly spread on the glass fiber non-woven fabric, placed between the high voltage alternating electric fields, and electrified such that that the powder is fully oscillated in it for 2 minutes and will be impregnated into the middle pores of the non-woven fabric.

Results: The final weight ratio of the aerogel powder to the whole material is 42 wt %. FIG. 1 is the electron micrograph photograph of the vertical cross-section of the aerogel composite material in Example 1. It can be seen that the aerogel powder is uniformly impregnated into the pores of the non-woven fabric from the upper surface to the lower surface of the porous fiber material. Due to the large impregnation amount and uniform impregnation of the aerogel powder, the aerogel composite material has good thermal insulation performance.

### Example 2

Material: JIOS aerogel Company AeroVa® aerogel powder, particle size: D50<50 m, density: 0.03-0.1 g/cm³, porosity>90%; Owens Corning glass fiber non-woven fabric, gram weight: 100 g/m², thickness: 1 mm, and air permeability: 1700˜1750 L/m²/s.

High voltage alternating electric field: Consist of two electrodes. One electrode is grounded, and the other electrode is powered by high voltage alternating current. The maximum voltage is ±20 kv, sine wave, and frequency is 600 HZ.

Implementation process: The aerogel powder is evenly spread on the glass fiber non-woven fabric, placed between the high voltage alternating electric fields, and electrified such that that the powder is fully oscillated in it for 2 minutes and will be impregnated into the middle pores of the non-woven fabric.

Results: The final weight ratio of the aerogel powder to the whole material is 32 wt %. FIGS. 2a, 2b, and 2c are respectively electron micrograph photographs of the vertical cross-section, front side, and back side of the aerogel composite material in Example 2.

Compared with FIG. 3a and FIG. 4a of Comparative Examples, it can be seen that the aerogel powder in the aerogel composite material of Example 2 is evenly distributed and the amount of impregnation is relatively large. Compared with FIG. 3b and FIG. 4b of Comparative Examples, it can be seen that the aerogel powder on the front side of the aerogel composite material in Example 2 is evenly distributed and the amount of impregnation is relatively large. From the distribution of the aerogel powder on the back of the aerogel composite material in the Comparative Examples shown in FIG. 3c and FIG. 4c, it can be seen that there is basically no aerogel powder due to insufficient impregnation amount and uneven distribution of the aerogel powder. However, the aerogel powder on the back of the aerogel composite material in Example 2 is evenly distributed, with relatively large impregnation amount.

### Example 3

Material: JIOS aerogel Company AeroVa® aerogel powder, particle size: D50<50 μm, density: 0.03-0.1 g/cm³, porosity>90%; Silicon carbide powder, particle size: 0.5 μm˜0.7 μm, density: 0.8˜0.9 g/cm³, etc. Owens Corning glass fiber non-woven fabric, gram weight: 100 g/m², thickness: 1 mm, and air permeability: 1700˜1750 L/m²/s.

High voltage alternating electric field: Consist of two electrodes. One electrode is grounded, and the other electrode is powered by high voltage alternating current. The maximum voltage is ±20 kv, sine wave, and frequency is 600 HZ.

Implementation process: The aerogel powder and silicon carbide powder are evenly dispersed and spread on the glass fiber non-woven fabric in a ratio of 9:1, placed between high voltage alternating electric fields, and electrified such that the powder is fully oscillated in it for 2 minutes and will be impregnated into the middle pores of the non-woven fabric.

Results: The final weight ratio of the aerogel and silicon carbide powder to the whole material is 41 wt %.

### Example 4

Material: JIOS aerogel Company AeroVa® aerogel powder, particle size: D50<50 μm, density: 0.03-0.1 g/cm³, porosity>90%; Glass fiber and polypropylene fiber blended felt, density: ˜90 kg/m³, thickness: ˜6 mm, and air permeability: 380˜420 L/m²/s.

High voltage alternating electric field: Consist of two electrodes. One electrode is grounded, and the other electrode is powered by high voltage alternating current. The maximum voltage is ±14 kv, sine wave, and frequency is 600 HZ.

Implementation process: The aerogel powder is evenly spread on the glass fiber non-woven fabric, placed between the high voltage alternating electric fields, and electrified such that the powder is fully oscillated in it for 2 minutes and will be impregnated into the middle pores of the non-woven fabric.

Results: The final weight ratio of the aerogel powder to the whole material is 35 wt %.

### Comparative Example 1

Material: JIOS aerogel Company AeroVa® aerogel powder, particle size: D50<50 μm, density: 0.03-0.1 g/cm³, porosity>90%; Owens Corning glass fiber non-woven fabric, gram weight: 125 g/m², thickness: 1.25 mm, and air permeability: 1300˜1350 L/m²/s.

Electrostatic spraying: Electrostatic high voltage: 20 KV, electrostatic current: 40 μA, powder pressure: 210 KPa, atomization pressure: 70 KPa, and powder bucket fluidization pressure: 35 KPa.

Implementation process: The non-woven fabric is placed on the horizontal desktop. The electrostatic spraying device is connected to a powder barrel and electrified. The parameters are adjusted. The switch is turned on to evenly coat the aerogel powder on the non-woven fabric, three times in total.

Results: The final weight ratio of the aerogel powder to the whole material is 12 wt %. FIGS. 3a, 3b, and 3c are respectively electron micrograph photographs of the vertical cross-section, front side and back side of the aerogel composite material in Comparative Example 1.

### Comparative Example 2

Material: JIOS aerogel Company AcroVa® aerogel powder, particle size: D50<50 μm, density: 0.03-0.1 g/cm³, porosity>90%; glass fiber and polypropylene fiber blended felt, gram weight: 540 g/m², thickness: 6 mm, and air permeability: 380˜420 L/m²/s.

Electrostatic spraying: Electrostatic high voltage: 20 KV, electrostatic current: 40 μA, powder pressure: 210 KPa, atomization pressure: 70 KPa, and powder bucket fluidization pressure: 35 KPa.

Implementation process: The blended felt is placed on the horizontal desktop. The electrostatic spraying device is connected to a powder barrel and electrified. The parameters are adjusted. The switch is turned on to evenly coat the aerogel powder on the non-woven fabric, three times in total.

Results: The final weight ratio of the aerogel powder to the whole material is 8 wt %. FIGS. 4a, 4b, and 4c are respectively electron micrograph photographs of the vertical cross-section, front side and back side of the aerogel composite material in Comparative Example 2.

### Comparative Example 3

Material: JIOS aerogel Company AeroVa® aerogel powder, particle size: D50<50 μm, density: 0.03-0.1 g/cm³, porosity>90%; Owens Corning needle felt, gram weight: 900 g/m², density: 60 kg/m², thickness: ˜15 mm, air permeability: 100-300 L/m²/s; and Solvent: ethanol.

Implementation process: The aerogel powder is stirred and dispersed in solvent ethanol to prepare a dispersion liquid with a mass concentration of 10 wt % and a viscosity of 18.1 cP. The dispersion liquid is added to the glass fiber felt, and the negative pressure is pumped to make the dispersion liquid fully impregnated. The glass fiber felt is naturally dried at room temperature for 24 hours, and then put into a 200° C. oven for 12 hours.

Results: The final weight ratio of the aerogel powder to the whole material is 22 wt %. The specific surface area data of aerogel after immersion of the dispersion liquid and drying are shown in Table 1.

### Comparative Example 4

Material: JIOS aerogel Company AeroVa® aerogel powder, particle size: D50<50 μm, density: 0.03-0.1 g/cm³, porosity>90%; Owens Corning needle felt, gram weight: 900 g/m², density: 60 kg/m², thickness: ˜15 mm, air permeability: 100-300 L/m²/s; and Solvent: n-hexane.

Implementation process: The aerogel powder is stirred and dispersed in solvent n-hexane to prepare a dispersion liquid with a mass concentration of 10 wt % and a viscosity of 6.24 cP. The dispersion liquid is added to the glass fiber felt, and the negative pressure is pumped to make the dispersion liquid fully impregnated. The glass fiber felt is naturally dried at room temperature for 24 hours, and then put into a 200° C. oven for 12 hours.

Results: The final weight ratio of the aerogel powder to the whole material is 21 wt %. The specific surface area data of aerogel after immersion of the dispersion liquid and drying are shown in Table 1.

### Comparative Example 5

Material: JIOS aerogel Company AeroVa® aerogel powder, particle size: D50<50 μm, density: 0.03-0.1 g/cm³, porosity>90%; Owens Corning glass fiber non-woven fabric, gram weight: ˜60 g/m², thickness: ˜0.6 mm, air permeability: 3000˜3100 L/m²/s; and Solvent: 75% water+25% ethanol.

Implementation process: The aerogel powder is stirred and dispersed in solvent to prepare a dispersion liquid with a mass concentration of 10 wt % and a viscosity of 12.1 cP. The dispersion liquid is added to the glass fiber felt, and the negative pressure is pumped to make the dispersion liquid fully impregnated. The glass fiber felt is naturally dried at room temperature for 24 hours, and then put into a 200° C. oven for 12 hours.

Results: The final weight ratio of the aerogel powder to the whole material is 20 wt %. The specific surface area data of aerogel after immersion of the dispersion liquid and drying are shown in Table 1.

Table 1 shows the pore structure changes of Comparative Examples 3, 4 and 5 after solvent treatment of the aerogel powder. Compared with untreated AeroVa® aerogel powder, the aerogels samples in Comparative Examples 3, 4 and 5 all show a decrease in specific surface area to varying degrees, and the porosity, or pore volume, decreases significantly, indicating that the nanopore in the aerogel powder is damaged in different degrees. The collapse of the inner space of the nanopore causes the pore volume to become smaller and the specific surface area to decrease. The present invention prevents the problem that the structure of the aerogel powder is destroyed by solution treatment due to direct impregnation of the aerogel powder into the porous fiber material through the alternating electric field, such that the aerogel composite material of the invention has better performance.

TABLE 1

| | BET Specific | | |
|---|---|---|---|
| | Surface Area | Porosity | Foam Porosity |
| | (m²/g) | (cm³/g) | Size (nm) |
| AeroVa ® Aerogel Powder | 688 | 3.07 | 16.7 |
| Comparative Example 3 | 654 | 2.83 | 17.3 |
| Comparative Example 4 | 654 | 2.75 | 16.8 |
| Comparative Example 5 | 687 | 2.69 | 14.0 |

In another aspect of the present invention, the aerogel powder of the aerogel composite material obtained by the aforementioned plurality of embodiments of impregnating the aerogel powder within the porous fiber material by alternating electric field has a large impregnation amount and is uniform such that the aerogel composite material has better thermal insulation properties. The process is simple, and the production cost is low. Based on this technology, the inventor further found that during subsequent packaging, transportation and use, the impregnated aerogel powder is prone to fall out from the aerogel composite material, which in turn affects the performance and use effect of the aerogel composite material, and the fallen aerogel powder is also prone to pollute the environment. In order to at least partially solve the above problems, the inventor innovatively proposes a treatment method for the aerogel powder through a large number of researches and experiments, which thereby at least partially solves the above technical problems.

The inventor has found through a large number of studies and experiments that by preheating the aerogel powder used in any embodiment of the present invention under specific conditions and then impregnating the preheated aerogel powder into a porous fiber material by means of an alternating electric field, the powder drop rate of the aerogel composite material obtained therefrom will be significantly reduced, and the fire-resistant properties of the aerogel composite material will also be significantly improved.

It should be noted here that there is currently no unified national (China) or international standard to define the powder loss rate or to specify a method for testing the rate. Especially in the field of aerogel products. There are not even any companies that disclose their own standards and test methods either. Based on this situation, in order to show the technical effect brought by the present invention, the inventor himself has defined two test methods to express the powder fallout rate, which is used to evaluate the powder fallout rate of the experimental examples and comparative examples in the embodiments, thereby reflecting that the powder fallout rate of the aerogel composite material manufactured by the technology disclosed in the present disclosure will be significantly reduced.

The first test method is the nitrile glove friction test method, where the tester wears nitrile gloves (e.g., TOUCHNTUFF*92-600) of composite standard GB 4806.9-2016 or ASTM D3578, and then slides and rubs the aerogel composite material with the size of an A4 paper (210 mm×297 mm) from left to right (or from right to left) three times. The amount of aerogel powder adsorbed on the nitrile glove is then observed and scored on a scale of 1 to 5 based on the amount adsorbed. Referring to FIG. 5, which shows the amount of aerogel powder adsorbed on the nitrile gloves after wiping different aerogel composite materials respectively, it can be seen that the amount of aerogel adsorbed on the left 1 figure is the most, with a score of 1, and the amount of aerogel adsorbed on the right 1 figure is the least, with a score of 5, i.e., the higher the score, the lower the powder fallout rate. The samples can basically be scored between 1 and 5 points. Through such comparative observation, it can also reflect that different samples have different powder fallout rates.

The second test method is the percentage content method, which, by shaking the test samples at a set time and a set shaking intensity, measures the mass before and after shaking, respectively, calculates the mass percentage of the lost content of aerogel, and then determines and reflects the different powder fallout rates of different samples.

Furthermore, the present invention specifically discloses a method of manufacturing the aerogel composite material, wherein the method comprises the following steps:
impregnating the pre-heated aerogel powder into a porous fiber material by applying an alternating electric field, wherein a voltage of the alternating electric field ranges from 0.1 KV to 200 KV; a frequency ranges from 0.1 HZ to 800 HZ; the aerogel powder has a density ranging from 0.01 g/cm³ to 0.5 g/cm³; the aerogel powder has an average particle size less than or equal to 500 μm; the pre-heat treatment temperature ranges from 300° C. to 600° C.; and the pre-heat treatment time is 30 minutes to 5 hours.

The present application does not place any limitations on the timing of the pre-heated aerogel powder. The step of preheating the aerogel powder may be performed by the aerogel powder manufacturer, i.e., preheating the aerogel powder after it has been manufactured; alternatively, the step may be performed by preheating the aerogel powder during the production of the aerogel composite material, and then impregnating it in the porous fiber material using the alternating electric field.

### Example 5

In this example, JIOS AEROVA® D50 aerogel powder is used, and the porous fiber material is CR33NI glass fiber non-woven felt. The aerogel powder of sample 51 is not pre-heated, and the aerogel powder of sample 52 is pre-heated at 500° C. for 30 minutes, wherein the atmosphere of the heat-treatment is air. The aerogel powders are then impregnated into CR33NI glass fiber non-woven felt, respectively, under the same conditions of alternating electric field. Sample 51 and sample 52 are tested for powder fallout rate, and the specific results are as follows:

TABLE 2

| | | | | | Thermal Insulation |
|---|---|---|---|---|---|
| | | | | Powder | (Backside Temperature |
| | Aerogel | Pre-heated | | Loss | after 15 Minutes of |
| Samples | Powder | Conditions | Substrate | Scores | Heating) |
| Sample 51 | JIOS | none | CR33NI | 1 | 290.9° C. |
| | AEROVA ® | | glass fiber | | |
| | D50 | | non-woven | | |
| | | | felt | | |
| Sample 52 | JIOS | 500° C., | CR33NI | 4.5 | 266° C. |
| | AEROVA ® | 30 minutes | glass fiber | | |
| | D50 | | non-woven | | |
| | | | felt | | |

It can be seen from data in Table 2 that, with other conditions remaining unchanged, the preheat treatment of the aerogel results in a significant decrease in the powder fallout rate of the aerogel composite material, as well as an improvement in the fire-resistant properties thereof.

### Example 6

Compared to Example 5, Example 6 only replaces the type of aerogel powder with zhongning AG-DC50 aerogel powder. In Example 6, the aerogel powder of sample 61 is not pre-heated, and the aerogel powder of sample 62 is pre-heated at 500° C. for 30 minutes, wherein the atmosphere of the heat treatment is air. The aerogel powders are then impregnated into CR33NI glass fiber non-woven felt, respectively, under the same conditions of alternating electric fields. Sample 61 and sample 62 are tested for powder fallout rate, and the specific results are as follows:

TABLE 3

| | | | | | Thermal Insulation |
|---|---|---|---|---|---|
| | | | | Powder | (Backside Temperature |
| | Aerogel | Pre-heated | | Loss | after 15 Minutes of |
| Samples | Powder | Conditions | Substrate | Scores | Heating) |
| Sample 61 | zhongning | none | CR33NI | 4 | 276.5° C. |
| | AG-DC50 | | glass fiber | | |
| | | | non-woven | | |
| | | | felt | | |
| Sample 62 | zhongning | 500° C., | CR33NI | 5 | 257° C. |
| | AG-DC50 | 30 minutes | glass fiber | | |
| | | | non-woven | | |
| | | | felt | | |

It can be seen from data in Table 2 that, with other conditions remaining unchanged, the preheat treatment of aerogel results in a decrease in the powder fallout rate of the aerogel composite material while the fire-resistant properties thereof are also improved. Moreover, it can thus be seen that pre-heat treatment of aerogel powder of different types and different manufacturers improves the powder fallout rate of the aerogel composite material. The technology disclosed in the present disclosure can be widely applied to aerogel powders of different sizes produced by various manufacturers.

### Example 7

This example uses JIOS AEROVA® D50 aerogel powder, and the porous fiber material is replaced with ZA75 glass fiber non-woven felt compared to Example 5. In Example 7, no preheat treatment is performed on sample 71; the aerogel powder of sample 72 is pre-heated at 300° C. for 30 minutes, wherein the atmosphere of the heat treatment is air; the aerogel powder of sample 73 is pre-heated at 400° C. for 30 minutes, wherein the atmosphere of the heat treatment is air; and the aerogel powder of sample 74 is pre-heated at 500° C. for 30 minutes, wherein the atmosphere of the heat treatment is air. The aerogel powder is then impregnated into ZA75 glass fiber non-woven felt, respectively, under the same conditions of alternating electric fields. Samples 71 to 74 are tested for powder fallout rate, and the specific results are as follows:

TABLE 4

| | | | | Powder | |
|---|---|---|---|---|---|
| | Aerogel | Pre-heated | | Loss | Loss Rate |
| Samples | Powder | Conditions | Substrate | Scores | (Percentage) |
| Sample 71 | JIOS | none | ZA75 glass fiber | 1 | 5.39 |
| | AEROVA ® | | non-woven felt | | |
| | D50 | | | | |
| Sample 72 | JIOS | 300° C., | ZA75 glass fiber | 1.5 | 5.12 |
| | AEROVA ® | 30 minutes | non-woven felt | | |
| | D50 | | | | |
| Sample 73 | JIOS | 400° C., | ZA75 glass fiber | 4 | 4.79 |
| | AEROVA ® | 30 minutes | non-woven felt | | |
| | D50 | | | | |
| Sample 74 | JIOS | 500° C., | ZA75 glass fiber | 4.5 | 4.31 |
| | AEROVA ® | 30 minutes | non-woven felt | | |
| | D50 | | | | |

It can be seen from data in Table 4 that, with other conditions remaining unchanged, the preheat treatment of aerogel results in a significant decrease in the powder fallout rate of the aerogel composite material, and the powder fallout rate also maintains a decreasing trend as the temperature of the preheat treatment is increased.

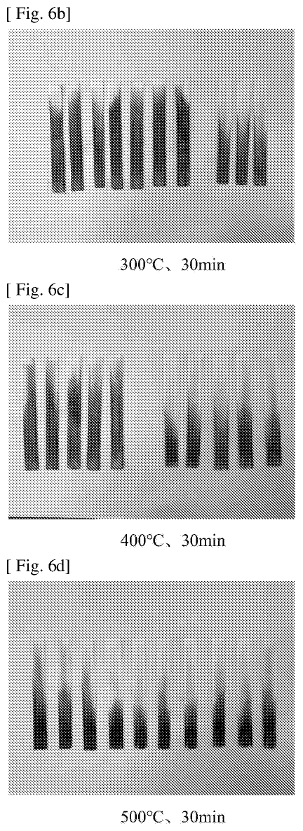

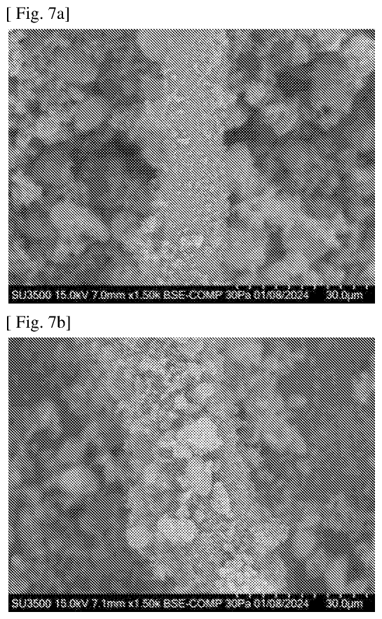

Also, refer to FIGS. 6a to 6d for photographs of samples 71 to 74 after burning tests. The samples 71 to 74 are each cut with a width of 13±0.5 mm and a length of 100±2 mm, and then cauterized for 10 seconds. The judgment is based on whether the flame burns to the clamping point (about 10 mm down from the top) to determine the flame retardancy. The flame retardancy of the samples (the number of samples that can be flame retarded out of 10 samples) is 0%, 30%, 50%, and 100% for samples 71-74, respectively. It can thus be seen from the comparison of samples 71-74 that the range of burning of the samples containing the pre-heated aerogel powder is smaller than that of the non-pre-heated ones, and with the increase of the pre-heat treatment temperature, the sample's burning range is also decreasing.

Referring to FIG. 7a and FIG. 7b further, FIG. 7a shows an electron micrograph photograph of sample 71, and FIG. 7b shows an electron micrograph photograph of sample 74. By comparison, it was found that the pre-heated aerogel powder is adsorbed more onto the glass fiber, which in turn reduces the powder drop rate.

In an optional embodiment, the pre-heated aerogel powder of the present disclosure can be directly applicable to the method defined in any of the preceding embodiments, i.e., the aerogel powder in the preceding Examples 1-4 can be replaced with the pre-heated aerogel powder. The voltage range of the alternating electric field, the selection of the porous fiber material, the additives in the aerogel powder, and the manner of applying the aerogel powder can be referred to the description of the foregoing embodiments, which will not be repeated herein.

The present invention innovatively uses a heat treatment process to pre-treat the aerogel powder, and then makes a secondary composite of the heat-treated aerogel powder and the porous fiber felt material. This technology can ensure that the porous fiber felt material is not damaged by high temperature, and due to the pre-heated treatment of the aerogel powder, the flame retardancy of the composite material is greatly improved, and at the same time, the reduction of the content of alkyl hydrophobic groups also improves its amphiphilicity with the porous fiber material, so that the powder dropout of the aerogel is greatly improved.

The inventor has found through studies that the percentage content of hydroxyl groups in the aerogel powder will be increased after the aerogel powder is pre-heated. Based on the current technical knowledge in the art, it is believed that the reasons for the increase may include the thermal decomposition of some methyl or alkyl groups due to the pre-heat treatment, such that the percentage content of hydroxyl groups will be increased.

In addition, because of the thermal decomposition of the methyl group or alkyl group by the pre-heat treatment, when the composite material is actually used, no flammable gas will continue to be generated due to heat, and the flame retardancy of the composite material is greatly improved. On the other hand, the increase in the percentage content of hydroxyl groups in the aerogel powder may be attributed to the generation of new hydroxyl groups, which may be generated either due to an intermediate product from the thermal decomposition of the alkyl groups or the heat of the aerogel powder. The increase in the percentage content of hydroxyl groups is only one of the reasons why the inventor believes that the powder loss of aerogel has been greatly improved, and it is not ruled out that there are other reasons. All in all, the powder fallout of aerogel of the composite material formed by impregnating the aerogel powder into the porous material is greatly improved by preheating the aerogel powder, and the flame retardancy of the composite material is greatly enhanced.

The present invention has been described through the above-mentioned embodiments, but it should be understood that the above-mentioned embodiments are only for the purpose of illustration and description, and are not intended to limit the present invention to the scope of the described embodiments. Furthermore, those skilled in the art can understand that the present invention is not limited to the above embodiments, and more variations and modifications can be made according to the teachings of the present invention. These variations and modifications fall within the protection scope claimed by the present invention.

1. An aerogel composite material comprising:
a porous fiber material; and
a preheated aerogel powder distributed in the porous fiber material, wherein the preheated aerogel powder was submitted to a heat-treatment within a temperature ranges from 300° C. to 600° C., during 30 minutes to 5 hours;
wherein the preheated aerogel powder is impregnated in the porous fiber material by applying an alternating electric field to the porous fiber material.

2. The aerogel composite material of claim 1, wherein a voltage of the alternating electric field ranges from about 0.1 KV to about 50 KV, and
wherein a frequency of the alternating electric field ranges from about 1 HZ to about 800 HZ; and
wherein an application time of the alternating electric field ranges from about 30 seconds to about 5 minutes.

3. The aerogel composite material of claim 1, wherein the porous fiber material is selected from a glass fiber felt, a glass fiber non-woven fabric, a glass fiber textile fabric, a ceramic fiber felt, a paper, a polyurethane fiber felt, a carbon fiber felt, a polypropylene fiber felt, a polypropylene and a glass fiber composite felt, and combinations thereof.

4. The aerogel composite material of claim 3, wherein a surface density of the glass fiber non-woven fabric is between about 20 g/m² and about 500 g/m²;
wherein a thickness of the glass fiber non-woven fabric is between about 0.3 mm and about 4 mm; and
wherein an air permeability of the glass fiber non-woven fabric is between about 200 L/m²/s and about 3000 L/m²/s.

5. The aerogel composite material of claim 4, wherein the surface density of the glass fiber non-woven fabric is between about 50 g/m² and about 150 g/m²;
wherein the thickness of the glass fiber non-woven fabric is between about 0.5 mm and about 1.5 mm; and
wherein the air permeability of the glass fiber non-woven fabric is between about 500 L/m²/s and about 2000 L/m²/s.

6. The aerogel composite material of claim 5, wherein the surface density of the glass fiber non-woven fabric is between about 90 g/m² and about 135 g/m²;
wherein the thickness of the glass fiber non-woven fabric is between about 0.8 mm and about 1.3 mm; and
wherein the air permeability of the glass fiber non-woven fabric is between about 1100 L/m²/s and about 1800 L/m²/s.

7. The aerogel composite material of claim 3, wherein the polypropylene and the glass fiber composite felt is made by blending a polypropylene fiber with a glass fiber;
wherein a density of the polypropylene and the glass fiber composite felt is between about 20 kg/m³ and about 200 kg/m³; and
wherein a thickness of the polypropylene and the glass fiber composite felt is between about 1 mm and about 20 mm.

8. The aerogel composite material of claim 7, wherein the density of the polypropylene and the glass fiber composite felt is between about 50 kg/m³ and about 150 kg/m³, and
wherein the thickness of the polypropylene and the glass fiber composite felt is between about 3 mm and about 10 mm.

9. The aerogel composite material of claim 1, wherein an additive for inhibiting thermal radiation is added to the aerogel powder;
wherein the additive is selected from at least one of silicon carbide, boron carbide, titanium oxide, and boron nitride; and
wherein a weight ratio of the additive to the aerogel powder ranges from about 1 wt % to about 15 wt %.

10. The aerogel composite material of claim 9, wherein the weight ratio of the additive to the aerogel powder ranges from about 5 wt % to about 12 wt %.

11. The aerogel composite material of claim 1, wherein a weight ratio of the aerogel powder to the aerogel composite material ranges from about 1 wt % to about 50 wt %.

12. A method of manufacturing an aerogel composite material comprising a porous fiber material; and a preheated aerogel powder, wherein the method comprises:
impregnating the pre-heated aerogel powder into the porous fiber material by applying an alternating electric field,
wherein a voltage of the alternating electric field ranges from about 0.1 KV to about 200 KV;
wherein a frequency of the alternating electric field ranges from about 0.1 HZ to about 800 HZ;
wherein the aerogel powder has a density ranging from about 0.01 g/cm³ to about 0.5 g/cm³;
wherein the aerogel powder has an average particle size less than or equal to about 500 μm;
wherein the pre-heat treatment temperature ranges from about 300° C. to about 600° C.; and
wherein the pre-heat treatment time is about 30 minutes to about 5 hours.

13. The method of claim 12, wherein an application time of the alternating electric field ranges from about 30 seconds to about 5 minutes.

14. The method of claim 12, further comprising at least one of (i) applying the aerogel powder to a surface of the porous fiber material; and (ii) applying the aerogel powder to a loader that is at least partially subject to the alternating electric field.

15. The method of claim 14, wherein the porous fiber material and the aerogel powder are arranged between a lower electrode and an upper electrode; and
wherein the lower electrode and the upper electrode are electrically insulated from each other through a dielectric and connected to a power supply such that the porous fiber material and the aerogel powder are subject to the alternating electric field.

16. A method of treating an aerogel powder, the method comprising:
heat treating an aerogel powder,
wherein the heat treatment temperature ranges from about 300° C. to about 600° C.; and
wherein the heat treatment time is about 30 minutes to about 5 hours.

17. The method of claim 16, wherein an atmosphere surrounding the heat treatment is air.
